(19) United States
(12) Patent Application Publication
(10) Pub. No.: US 2007/0109257 A1
(43) Pub. Date: May 17, 2007

(54) Wireless virtual computer operating platform device

(76) Inventors: James Lee, Pasadena, CA (US); John Gevisser, London (GB); Jarred Cinman, Johannesburg (ZA); Emma Kaye, Mouille Point (ZA)

Correspondence Address: TROXELL LAW OFFICE PLLC, SUITE 1404, 5205 LEESBURG PIKE, FALLS CHURCH, VA, 22041, US

(21) Appl. No.: 11/274,161

(22) Filed: Nov. 16, 2005

(51) Int. Cl. G09G 5/00

(52) U.S. Cl. 345/156; 340/825.69; 345/169

(57) ABSTRACT

A wireless virtual computer operating platform device includes a main computer, a wireless transmission device, and a wireless virtual host computer. The main computer is capable of providing a audio-video signal and receiving at least the working signal of an operating unit, and displaying on a display unit through processing. The wireless transmitting device being electrically connected to the main computer further includes a wireless transmitting module and a wireless receiving module. The wireless transmitting module is capable of receiving the audio-video signal and transmitting off a wireless signal. The wireless virtual host computer is capable of receiving the wireless signal, decoding it and displaying on a screen. In addition, the wireless virtual host computer, by the use of an externally controlled module, receives a control signal operated by the user to generate a corresponding control signal, and display on the screen. The control signal, after receiving by the wireless receiving module, can transmit back to the main computer to be processed and then display on the display unit.

### BACKGROUND OF THE INVENTION

1. Field of the Invention

The invention relates to a wireless virtual computer operating platform device, and more particularly, to a computer device that is portably operated in a fixed range of area, and is simple in structure as well as low in cost.

2. Description of the Prior Art

In general, the principal and widespread constituted elements of the portable wireless operation platform devices, disregarding whether it is a personal computer, a notebook computer, even as small size as PDA (personal digital assistant), must have equipped, in the operation platform, a CPU (central processing unit) and relevant memories. These memories commonly include, for example, a DRAM for temporarily storing the processing data, and a hard disk or ROM for storing operating system software. Not only these constituted elements make the overall hardware structure very complicated, they are also very high in manufacturing cost and not easy to maintain. For those users who need only simple demand and low operating speed, these portable wireless operation platform devices are not economically effective.

Moreover, since each of the above-mentioned conventional operation platform devices must equip with operation software system, the procurement cost oftentimes is higher than the purchasing cost of the hardware. In addition, this will increase the probability of making mistakes. Therefore, having some improvements on the above-mentioned situation is necessary.

### SUMMARY OF THE INVENTION

In light of the above-mentioned disadvantages of the prior art, the invention provides a wireless virtual computer operating platform device that is simple in structure, low cost in assembling, easy to maintain, thereby it can effectively lower the service cost. It aims to ameliorate at least some of the disadvantages of the prior art or to provide a useful alternative.

The primary objective of the invention is to provide a wireless virtual computer operating platform device without the need of implementing relevant operating software system that can effectively save the purchasing cost of the system's operating software, and in the meantime, effectively reduce the mistakes generated by the software system.

The secondary objective of the invention is to provide a wireless virtual computer operating platform device that does not need to implement a relevant operating software system and can effectively save the purchasing cost of system's operating software, and in the meantime can effectively reduce the mistakes generated by the software system.

The another objective of the invention is to provide a wireless virtual computer operating platform device capable of performing wireless transmitting in a fixed range of area to make the wireless virtual host computer attain the same function as that of the main computer.

One further objective of the invention is to provide a wireless virtual computer operating platform device that can make the wireless virtual host computer receive the main computer's game program to facilitate the users to perform video game within a fixed range of area

To achieve the above-mentioned objective, the wireless virtual computer operating platform device of the invention includes a main computer, a wireless transmission device, and a wireless virtual host computer. The main computer is capable of providing a audio-video signal and receiving at least the working signal of an operating unit, and displaying on a display unit through processing. The wireless transmitting device being electrically connected to the main computer further includes a wireless transmitting module and a wireless receiving module. The wireless transmitting module is capable of receiving the audio-video signal and transmitting off a wireless signal. The wireless virtual host computer is capable of receiving the wireless signal, decoding it and displaying on a screen. In addition, the wireless virtual host computer, by the use of an externally controlled module, receives a control signal operated by the user to generate a corresponding control signal, and display on the screen. The control signal, after receiving by the wireless receiving module, can transmit back to the main computer to be processed and then display on the display unit.

The accomplishment of this and other objectives of the invention will become apparent from the following description and its accompanying drawings of which:

### BRIEF DESCRIPTION OF THE DRAWINGS

FIG. 1 is a pictorial view of a schematic structural diagram of a wireless virtual computer operating platform device of a preferred embodiment of the invention.

FIG. 2 is a block diagram of the structure of a wireless virtual computer operating platform device of the invention.

### DETAILED DESCRIPTION OF THE PREFERRED EMBODIMENT

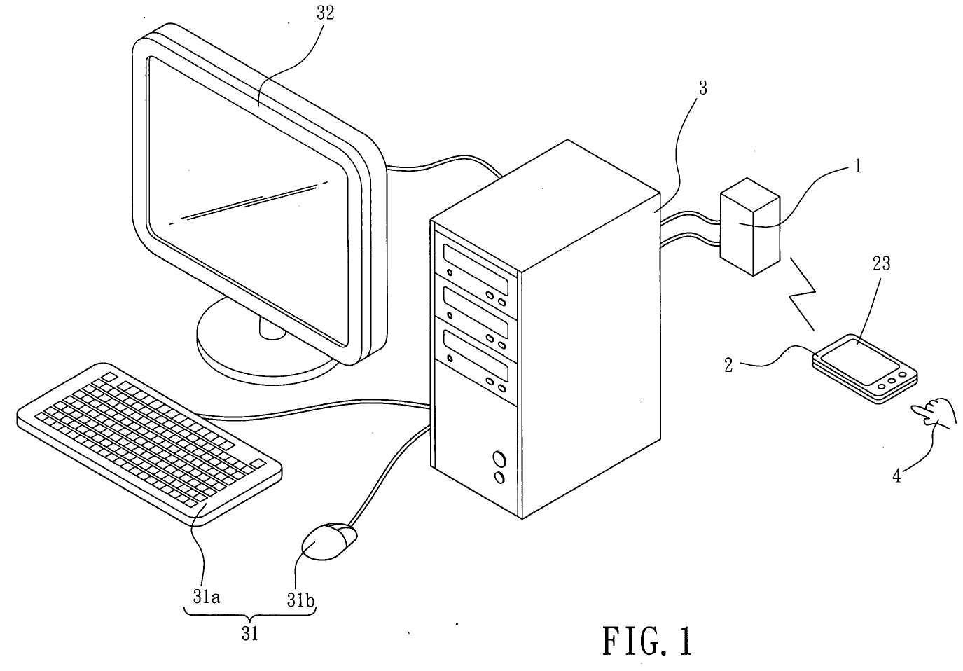

FIG. 1 is a pictorial view of a schematic structural diagram of a wireless virtual computer operating platform device of a preferred embodiment of the invention. As shown in FIG. 1, the wireless virtual computer operating platform device includes a main computer (3), a wireless transmission device (1), and a wireless virtual host computer (2). The main computer (3) is capable of providing a video signal and receiving at least the working signal of an operating unit (31) which can be a keyboard (31a) or a mouse (31b), and displaying on a display unit (32) which preferably is a liquid crystal screen, through processing.

The wireless transmitting device (1) is electrically connected to the main computer (3) and capable of receiving a video-audio signal provided by the main computer (3). The signal transmits off to form a wireless signal which after being received by the wireless virtual host computer (2), which preferably is a personal digital assistant (PDA), is decoded and displayed on a screen (23) which is preferably a liquid crystal screen.

A user (4) then operates the wireless transmitting device (1) and generates a corresponding control signal that is displayed on the screen (23) on the one hand and is received by the wireless transmitting device (1) on the other hand. Afterwards, the control signal is transmitted back to the main computer (3) to be processed and is displayed on the display unit (32).

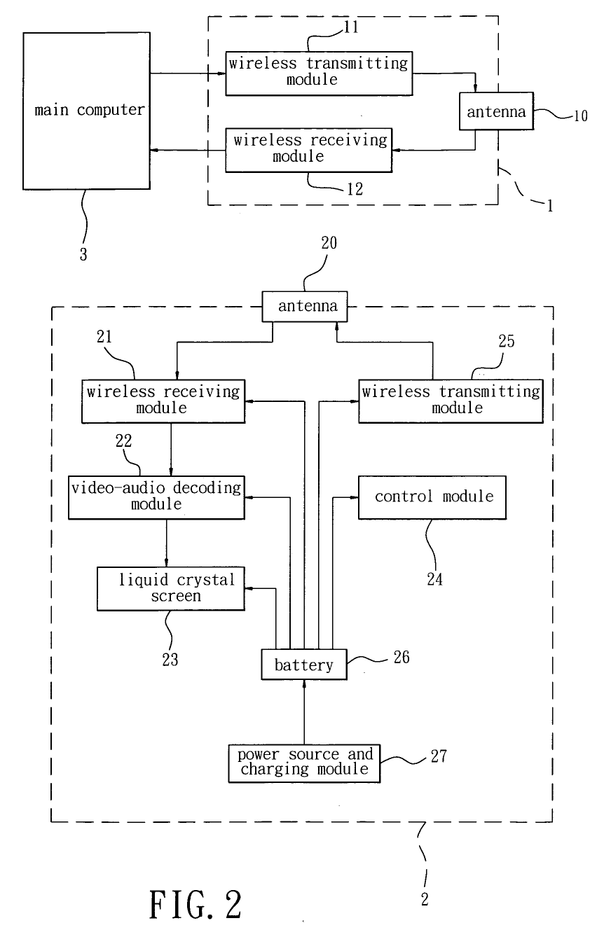

FIG. 2 is a block diagram of the structure of a wireless virtual computer operating platform device of the invention. By referring to the block diagram of FIG. 2, it is understood that the invention mainly includes two parts, namely a wireless transmitting device (1) and a wireless virtual host computer (2); where the wireless transmitting device (1) includes a wireless transmitting module (11), a wireless receiving module (12), and an antenna (10). The input end of the wireless transmitting module (11) is, by wire-mode, connected to the output end (e.g. AV connector of VGA or AGP display card, AV connector of sound card) of video-audio signal of a preset main computer (3) while the input end of the wireless receiving module (12) is connected to the antenna (10). Moreover, the output end of the wireless receiving module (12) is, by wire-mode (e.g. through series, parallel ports), connected to the output/input ports of the main computer (3). The wireless virtual host computer (2) consists of a wireless receiving module (21), a video-audio decoding module (22), a liquid crystal screen (23), an externally controlled module (24), a wireless transmitting module (25), a battery (26), as well as a power source-and-charging module (27). The input end of the wireless receiving module (21) and the output end of the wireless transmitting module (25) are connected simultaneously to an antenna (20) while the output end of the wireless receiving module (21) can be connected to the liquid crystal screen (23) through the video-audio decoding module (22). Moreover, the input end of the wireless transmitting module (25) is bound to the output end of the externally controlled module (24). What is more, the power source-and-charging module (27), being able to convert the external power source into direct current, besides being able to charge the battery (26), it can indirectly provide power required by the above-mentioned module elements.

When it comes to use, the wireless transmitting module (11) of the wireless transmitting device (1) receives the video-audio signal of the main computer (3) and transmits off through the antenna (10). The signal then is received through the decoding of the video-audio decoding module (22) via the antenna (20) and is displayed on the liquid crystal screen (23). Moreover, the user can operate the externally controlled module (24) to make it generate the corresponding control signal and output to the wireless transmitting module (25), then transmit off via the antenna (20). What is more, by making use of the wireless receiving module (12) of the above-mentioned wireless transmitting device (1) to receive the control signal via the antenna (10), the signal can transmit back to the main computer (3) to be manipulated, and perform the pertinent operations. In this way, it can form a controllable operation for the wireless virtual (without CPU and pertinent DRAM memory, hard disk or ROM) computer operation-platform device.

The externally controlled module (24) of the above-mentioned wireless virtual host computer (2) of the invention can have various embodiments. Listed below are part of the embodiment structures:
1. The externally controlled module (24) is equipped with a touch controlled glass disposed on the surface of the liquid crystal screen (23) for the user to touch so as to generate pertaining touch signal, thereby it will become a pertaining control signal output through the manipulation of a control module.
2. The externally controlled module (24), being a wireless mouse and its signal receiving device, makes use of the signal receiving device to receive the control signal of the wireless mouse and output.
3. The externally controlled module (24) is a wire-mode mouse and its signal-processing unit.

To sum up, the wireless virtual computer operating platform device has the efficacies of being simple in structure, low in cost, and convenient to carry.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A wireless virtual computer operating platform device, comprising:
a main computer capable of providing a video signal and receiving at least the working signal of an operating unit, and displaying on a display unit through processing;
a wireless transmission device electrically connected to the main computer, further comprising:
a wireless transmitting module capable of receiving the video signal and transmitting off a wireless signal; and
a wireless receiving module; and
a wireless virtual host computer, further comprising:
a receiving module capable of receiving the wireless signal;
a video-audio decoding module for decoding the wireless signal;
an externally controlled module capable of receiving a corresponding control signal operated by the user to generate;
a screen for displaying the decoded wireless signal and the control signal; and
a transmitting module capable of transmitting the control signal;
wherein after making use of the wireless receiving module to receive the control signal, transmitting back to the main computer and displaying on the display unit.

2. The wireless virtual computer operating platform device as claimed in claim 1, wherein the main computer further comprises a video-audio signal output terminal and an out/input port.

3. The wireless virtual computer operating platform device as claimed in claim 2, wherein the wireless transmitting device is connected to the video-audio signal output terminal and the out/input port respectively by a signal wire.

4. The wireless virtual computer operating platform device as claimed in claim 1, wherein the wireless transmitting module of the wireless transmitting device is connected to the main computer by the use of an AV connector.

5. The wireless virtual computer operating platform device as claimed in claim 1, wherein the wireless receiving module of the wireless transmitting device is connected to the main computer by the use of a series of ports.

6. The wireless virtual computer operating platform device as claimed in claim 1, wherein the wireless virtual host computer is a personal digital assistant device (PDA).

7. The wireless virtual computer operating platform device as claimed in claim 1, wherein the externally controlled module further comprises a touch controlled glass and a control module wherein the touch controlled glass is disposed on the surface of the liquid crystal screen to be controlled by the user in order to drive the control module for generating control signal to be transmitted off.

8. The wireless virtual computer operating platform device as claimed in claim 1, wherein the externally controlled module further comprises a wireless mouse and a mouse signal receiving device.

9. The wireless virtual computer operating platform device as claimed in claim 1, wherein the externally controlled module further comprises a wire-mode mouse and a mouse signal processing unit.

10. The wireless virtual computer operating platform device as claimed in claim 1, wherein the wireless virtual host computer is a video game device.
